(19) United States
(12) Patent Application Publication
(10) Pub. No.: US 2019/0301147 A1
(43) Pub. Date: Oct. 3, 2019

(54) Shower structure with soap supply function

(71) Applicants: CHIN-LUNG WU, Taichung City (TW); WEI-SHENG WU, New Taipei City (TW)

(72) Inventors: CHIN-LUNG WU, Taichung City (TW); WEI-SHENG WU, New Taipei City (TW)

(21) Appl. No.: 15/939,191

(22) Filed: Mar. 28, 2018

(51) Int. Cl. E03C 1/04; A47K 5/12; E03C 1/02

(52) U.S. Cl. CPC E03C 1/0408; E03C 1/0404; E03C 1/025; A47K 5/12

(57) ABSTRACT

A shower structure with a soap supply function includes a top shower head, a handheld shower head, and a water separator with a switching button. The water separator has two water outlets coupled to the top shower head and the handheld shower head respectively. A soap dispenser with at least one containing space is installed at the external periphery of the water separator, and a liquid outlet is formed on a free side, and a press button is installed on a side of the soap dispenser. The press button may be press to dispense a soap stored in the soap dispenser flows out from the liquid outlet. The shower structure not just ensures the aesthetic appearance of the shower space only, but also allows users to identify and use the soap clearly and conveniently.

### FIELD OF THE INVENTION

The present disclosure relates to a shower structure with a soap supply function, in particular to a shower head combined with a soap supply function.

### BACKGROUND OF THE INVENTION

To take a shower, most people hold a shower head to wash their body first and then put some shower gel or soap onto their body for cleaning. Therefore, bottles of shampoo, conditioner, and shower gel are placed in their shower space, not just causing a messy spatial arrangement or affecting the aesthetic appearance of the shower space only, but also making it uneasy for the users to identify and use the bottles of shampoo, conditioner, or shower gel conveniently. Obviously, such arrangement requires improvements.

### SUMMARY OF THE INVENTION

Therefore, it is a primary objective of the present invention to overcome the aforementioned drawbacks by providing a shower structure with a soap supply function to ensure the aesthetic appearance of the shower space and allow users to visually identify and use the soap conveniently.

To achieve the aforementioned and other objectives, the present invention provides a shower structure with a soap supply function, comprising: a top shower head, a handheld shower head and a water separator with a switching button, and the water separator having a water inlet and two water outlets, and the water inlet being coupled to the water source, and each water outlet being coupled to the top shower head and the handheld shower head, characterized in that a soap dispenser with at least one containing space is installed at the external periphery of the water separator, and a liquid outlet is disposed on a free side of the soap dispenser, and a press button is installed on a side of the soap dispenser, so that when the press button is pressed, a soap contained in the containing space of the soap dispenser flows out from the liquid outlet.

The shower structure further comprises a connecting hose with both ends coupled to the water outlet of the water separator and the handheld shower head respectively.

The shower structure further comprises a hanging frame fixed to a predetermine position of the water separator.

Wherein, the soap dispenser is slidably latched to the water separator.

Wherein, the soap dispenser is hooked to the water separator.

### BRIEF DESCRIPTION OF THE DRAWINGS

FIG. 1 is a perspective view of this disclosure;

FIG. 2 is an exploded view of this disclosure;

FIG. 3 is a cross-sectional view of this disclosure; and

FIG. 4 is a schematic view of pressing and operating a shower structure with a soap supply function in accordance with an embodiment of this disclosure.

### DESCRIPTION OF THE PREFERRED EMBODIMENTS

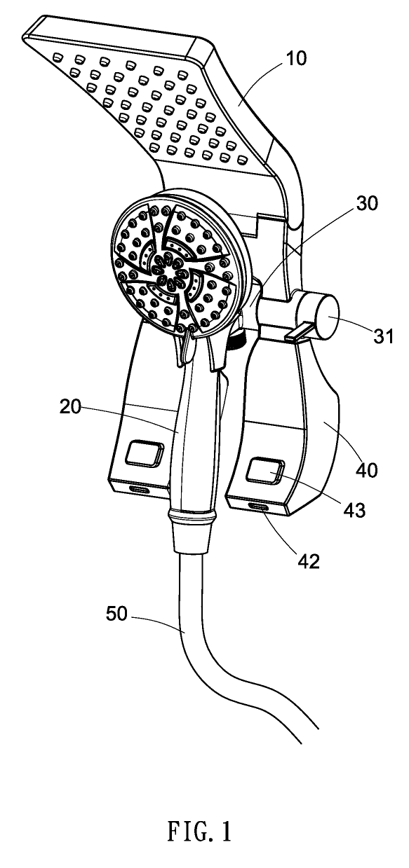

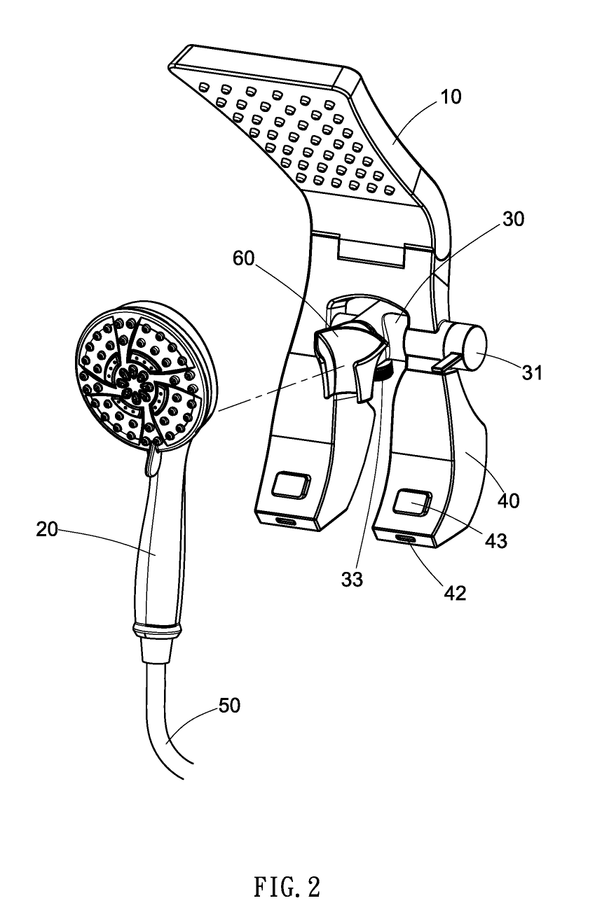

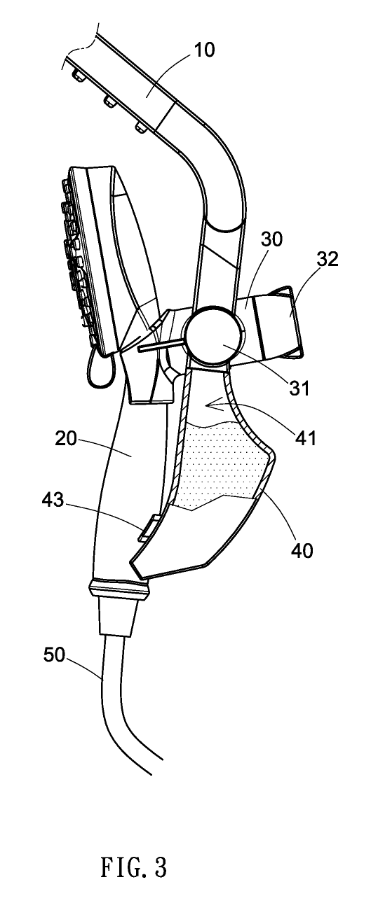

With reference to FIGS. 1 to 4 for a shower structure with a soap supply function according to this disclosure, the shower structure with a soap supply function comprises a top shower head 10, a handheld shower head 20 and a water separator 30 with a switching button 31, and the water separator 30 has a water inlet 32 and two water outlets 33, and the water inlet 32 is coupled to a water source (not shown in the figure), and each water outlet 33 is coupled to the top shower head 10 and the handheld shower head 20.

It is noteworthy that a soap dispenser 40 with at least one containing space 41 is installed at the external periphery of the water separator 30, and a liquid outlet 42 is disposed on a free side of the soap dispenser 40, and a press button 43 is installed on a side of the soap dispenser 40. When the press button 43 is pressed, a soap stored in the containing space 41 of the soap dispenser 40 flows out from the liquid outlet 42.

The shower structure further comprises a connecting hose 50 with both ends coupled to the water outlet 33 of the water separator 30 and the handheld shower head 20 respectively.

The shower structure further comprises a hanging frame 60 fixed to a predetermined position of the water separator 30 for hanging and positioning the handheld shower head 20.

Wherein, the soap dispenser 40 is slidably latched to the water separator 30 (not shown in the figure).

Wherein, the soap dispenser 40 is hooked to the water separator 30 (not shown in the figure).

In FIGS. 1 to 4, when a user is taking a shower, the user holds the handheld shower head 20 directly, and then turns on a thermostat faucet handle (not shown in the figure) to enter water from the water inlet 32 of the water separator 30 to the top shower head 10 or the handheld shower head 20 according to the switching by the switching button 31 of the water separator 30, so as to achieve the effect of taking a shower. The whole operation is simple and convenient.

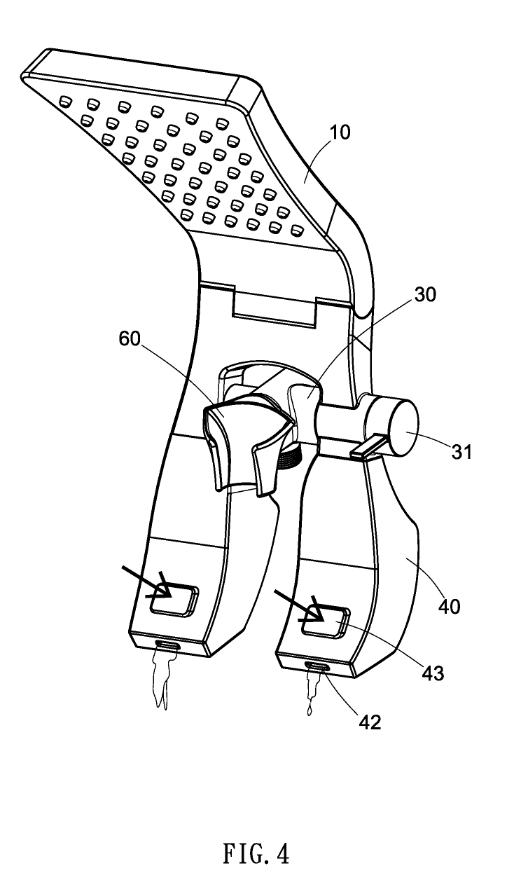

It is noteworthy that the soap dispenser 40 with at least one containing space 41 of this disclosure is installed at the external periphery of the water separator 30, and shampoo, conditioner or shower gel may be filled into the containing space 41 of the soap dispenser 40. When the user presses the press button 43, the soap contained in the containing space 41 of the soap dispenser 40 flows out from the liquid outlet 42 (as shown in FIG. 4) for the users to take the shower. The operation is simple and convenient. The design of this disclosure not just prevents a messy spatial arrangement to ensure the aesthetic appearance of the shower space only, but also allows the users to clearly identify and conveniently use the soap without picking the wrong bottle. The application of this disclosure is very convenient.

What is claimed is:

1. A shower structure with a soap supply function, comprising a top shower head, a handheld shower head and a water separator with a switching button, and the water separator having a water inlet and two water outlets, and the water inlet being coupled to the water source, and each water outlet being coupled to the top shower head and the handheld shower head, characterized in that a soap dispenser with at least one containing space is installed at the external periphery of the water separator, and a liquid outlet is disposed on a free side of the soap dispenser, and a press button is installed on a side of the soap dispenser, so that when the press button is pressed, a soap contained in the containing space of the soap dispenser flows out from the liquid outlet.

2. The shower structure with a soap supply function according to claim 1, further comprising a connecting hose with both ends coupled to the water outlet of the water separator and the handheld shower head respectively.

3. The shower structure with a soap supply function according to claim 1, further comprising a hanging frame fixed to a predetermined position of the hanging frame.

4. The shower structure with a soap supply function according to claim 1, wherein the soap dispenser is slidably latched to the water separator.

5. The shower structure with a soap supply function according to claim 1, wherein the soap dispenser is hooked to the water separator.
